(19) United States
(12) Patent Application Publication
(10) Pub. No.: US 2026/0191157 A1
(43) Pub. Date: Jul. 9, 2026

(54) Self Powered Fluid Control Valve

(71) Applicant: Bradford Thomas Hite, Valencia, CA (US)

(72) Inventor: Bradford Thomas Hite, Valencia, CA (US)

(21) Appl. No.: 19/009,874

(22) Filed: Jan. 3, 2025

(51) Int. Cl. A01G 25/16

(52) U.S. Cl. CPC A01G 25/165

(57) ABSTRACT

A unique system for the implementation of an automated fluid control system is disclosed whereby individual valves support internal power generation and control/status data communications are performed via an acoustic pressure wave digital data interface. Internal valve power generation is achieved by a fluid driven voltage generator operating when the valve is active. Local energy storage is provided within each valve to maintain the communications interface during valve inactive time. Acoustic pressure wave communications within the fluid source pipe network is utilized to provide low rate control/status data transactions. The combination of valve station internal self powering and pressure wave communications serves to eliminate all wired connections between the control module and individual valve stations.

### CROSS-REFERENCES TO RELATED APPLICATIONS

Not Applicable.

### STATEMENT REGARDING FEDERALLY SPONSORED RESEARCH OR DEVELOPMENT

Not Applicable.

### REFERENCES CITED

Not Applicable

### BACKGROUND OF THE INVENTION

### 1. Field of the Invention

This invention relates to the field of automatic fluid control valves commonly found in residential, commercial and industrial applications. The most wide spread application is fluid (water) control for garden, agriculture or landscape water irrigation systems. The present invention provides for integration of internal self power generation within the valve station thereby eliminating external power connection or conveyance needs. The invention further implements control/data transactions between valve and control stations utilizing acoustic pressure wave communications within the piped fluid supply system. Low cost connection of multiple valve stations to a common controller module is achieved free of the normally required wired connection for digital control/data and power signals. Reliability enhancements are provided by a wireless design approach eliminating components within the fluid control system installation being prone to damage or failure. The present invention leverages off acoustic pressure wave based digital communications between valve/controller and self power generation within each valve station enabling a simpler and more robust system concept.

### 2. Description of the Related Art

The most common example of a fluid control system is the applications and marketplace found within irrigation systems being a mature field for over 40 years. Overall, the usage applications can be split into home automated sprinkler systems or much larger commercial agriculture systems. Both system types are commonly organized around a central controller node and multiple remote valve stations to automatically oversee the distribution of water. Multiple commercial vendors service the irrigation market offering separate products such as computer based controller nodes, flow/pressure/moisture sensors and valve components. Recently, these products have been upgraded to include newer solar or wireless technology for performing the same overall water distribution function.

A typical irrigation system is shown in reference system block diagram FIG. 1 for a multiple valve configuration. Water supply 100 provides the source of water to be controlled by the system. AC power input 102 provides electrical power necessary to actuate each valve and power controller module 104. User display 106 and User controls 108 allow an operator to configure and interact with the system by interfacing with control software 110. Voltage switching bank 112 individually selects a valve for actuation based on commands from control software 110. AC input voltage 102 is reduced by a transformer prior to input to voltage switching bank 112. Individual valves in valve group 114 are connected to common water supply 100 at the inlet port and an irrigation circuit at the outlet port. Each valve has a separate point-to-point two wire power interface to the controller module associated with individual switches in voltage switching bank 112. Irrigation circuits within group 116 are individually activated based on valve turn on or off.

Problems can arise in automated irrigation systems whereby wired inter-connections supplying power and control functions are both hard to access and troubleshoot. The elimination of these wired connections can serve to simplify system installation and offer improved long term reliability. Recently, vendors have started to offer system component options aimed at eliminating wired connections using solar power and RF wireless communications. While these particular component options eliminate wiring, they also complicate the system configuration and installation. The usage of solar power and RF communication methods will require external additional external components and cabling added to each valve station. These components being above ground are subject to damage and degraded performance from the open environment. Further, installation considerations must be made for antenna placement supporting RF signal propagation and solar panel sunlight exposure within the physical location.

The field of commercial micro turbine generators is mature with multiple vendors offering products sized from 0.5 W to 10 W with an output voltage range of 5V to 24V. Typical form factor for these generators are pipe fitting (NTP or press-on) or a waterwheel allowing fluid to flow through the device. Applications for these devices with output power levels below 100 W are extremely limited and require continuous fluid flow to operationally generate usable and stable power. One currently available example of a micro water turbine generator is the Beduan model 1 KL-06220-MHG with G½″ male threaded fittings capable of providing 10 W at 24 VAC. An external voltage regulator is required since the generator output voltage is proportional to the water pressure. The present invention is well suited for either a DC latching solenoid or AC solenoid type valves. A DC latching valve typically will require a 50 mS pulse of 1.5 A at 9V-12V (0.7 Joules) to latch the solenoid and open the valve continuing with no power draw if the valve remains open or closed. The disadvantage of the DC latching valve is it must be actively shutoff (not intrinsically safe) whereby the present invention has built-in electronics to guarantee shutoff control. In comparison, a low power AC solenoid valve can require a constant 0.5 W at 24V is intrinsically safe since the removal of power shuts the valve. These low valve power levels along with the minimal recharge time to replace the energy storage device supplied start up energy allow the present invention to utilize a low wattage sized micro turbine generator.

Data communications for the present invention are implemented wirelessly using transducer based acoustic pressure waves within the fluid supply or source feed network. This communications interface type is preferred due to the lack of external components when compared to a radio frequency based interface. Recent studies have identified acoustic pressure communications as a possible alternative to RF based systems for urban water networks. One particular study “From Radio to In-Pipe Acoustic Communications for Smart Water Networks in Urban Environments: Design Challenges and Future Trends” dated 4 Oct. 2023 by Fishta el al details the current state of this industry and challenges associated with implementation. The study goes on to describe several experimental systems using OOK modulation at carrier frequencies below 500 Hz to traverse distances greater then 165 meters. Transmit and receive transducers were of the common piezoelectric type mounted externally to the pipe wall thereby introducing no restrictive obstacles within the fluid flow pathway. While the bit data rates supported by these proposed interfaces are quite low, around 2 Hz, control of a multi valve system by a central station is easily supported due to minimal operating time constraints. The study mentions due to the long time periods and power required for even minimal data communications result in a shortened battery life for remotely placed sensors. The present invention mitigates this effect with capability to recharge the local valve energy storage device based on periodic usage.

### BRIEF SUMMARY OF THE INVENTION

The present invention comprises an automated fluid control system whereby individual valves support internal power generation and control/status data communications are performed via an acoustic pressure wave digital data interface. Internal valve power generation is achieved by a fluid driven voltage generator operating when the valve is active or open. Local energy storage is provided within each valve to maintain the communications interface during valve inactive time or off. Acoustic pressure wave communications within the fluid source pipe network is utilized to provide low rate control/status data transactions. The combination of valve station internal self powering and pressure wave communications serves to eliminate all wired connections between the control module and individual valve stations. Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

FIG. 1 is a reference system block diagram showing a typical irrigation integrated system.

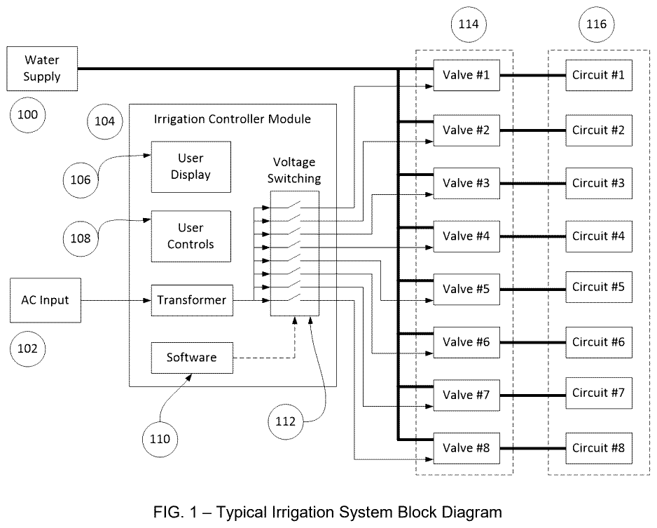

FIG. 2 is a system block diagram for the preferred embodiment of the present invention.

FIG. 3 is a block diagram detailing the valve component for the preferred embodiment of the present invention.

FIG. 4 is an example software flow chart detailing the controller module software function process steps.

FIG. 5 is an example software flow chart detailing the valve station control software function process steps.

### REFERENCE NUMERALS IN THE DRAWINGS

| | | | |
|---|---|---|---|
| 100 | Water Supply | 102 | AC Power Input |
| 104 | Irrigation Control | 106 | User Display for |
| | Module | | Control Module |
| 108 | User Controls for | 110 | Control Software |
| | Control Module | | |
| 112 | Voltage Switch Bank | 114 | Remote Valve Group |
| 116 | Water Irrigation | | |
| | Output Circuit Group | | |
| 200 | Fluid Supply | 202 | User Display for |
| | System | | Control Module |
| 204 | User Controls for | 206 | Control Module |
| | Control Module | | Housing |
| 208 | Data Modem | 210 | Control Software |
| 212 | Pressure | 214 | Transducer Connection |
| | Transducer | | to Fluid Supply |
| 216 | Remote Valve | 218 | Output Circuit Group |
| | Group | | |
| 220 | Individual Valve | | |
| | Component | | |
| 300 | Fluid Supply | 302 | Fluid Control Valve |
| | System | | Module Housing |
| 304 | Housing Fluid Inlet | 306 | Inlet Pressure Sensor |
| | Port | | (Optional) |
| 308 | Fluid Control Valve | 310 | Valve Solenoid |
| | | | Actuator |
| 312 | Voltage Switch | 314 | Output Switched Circuit |
| 316 | Transducer | 318 | Valve Module |
| | Connection to Fluid | | Electronics |
| | Inlet Port | | |
| 320 | Power Supply | 322 | Energy Storage Device |
| | Circuit | | |
| 324 | Pressure | 326 | Voltage Generator |
| | Transducer | | Circuit |
| 328 | Processor | 330 | Control Software |
| | Executing Control | | |
| | Software | | |
| 332 | Data Modem | 334 | Housing Fluid Outlet |
| | | | Port |
| 400 | Initialize Program | 402 | Initialize Modem |
| | Variables Process | | Interface Process Step |
| | Step | | |
| 404 | User Control | 406 | Scheduled Event |
| | Input Decision Block | | Decision Block |
| 408 | Execute User | 410 | Update Program |
| | Command | | Variables Process Step |
| | Process Step | | |
| 412 | Update Display | 414 | Update Event |
| | Process Step | | Schedule Process Step |
| 416 | Decode Event | 418 | Determine Valve |
| | Process Step | | Station ID Process |
| | | | Step |
| 420 | Turn On Valve | 422 | Request Valve Status |
| | Event Decision Block | | Decision Block |
| 424 | Send Valve On | 426 | Send Valve Status |
| | Command to | | Request Command to |
| | Station ID | | Station ID Process |
| | Process Step | | Step |
| 428 | Receive Valve | | |
| | Status Process Step | | |
| 500 | Initialize Program | 502 | Initialize Modem |
| | Variables Process Step | | Interface Process Step |
| 504 | Control | 506 | Energize Solenoid |
| | Message | | Voltage Process Step |
| | Received | | |
| | Decision Block | | |
| 508 | Send Valve | 510 | Station Match Decision |
| | Status Process Step | | Block |
| 512 | Turn ON Valve | 514 | Request Valve Status |
| | Event Decision | | Event Decision Block |
| | Block | | |

### DETAILED DESCRIPTION OF THE INVENTION

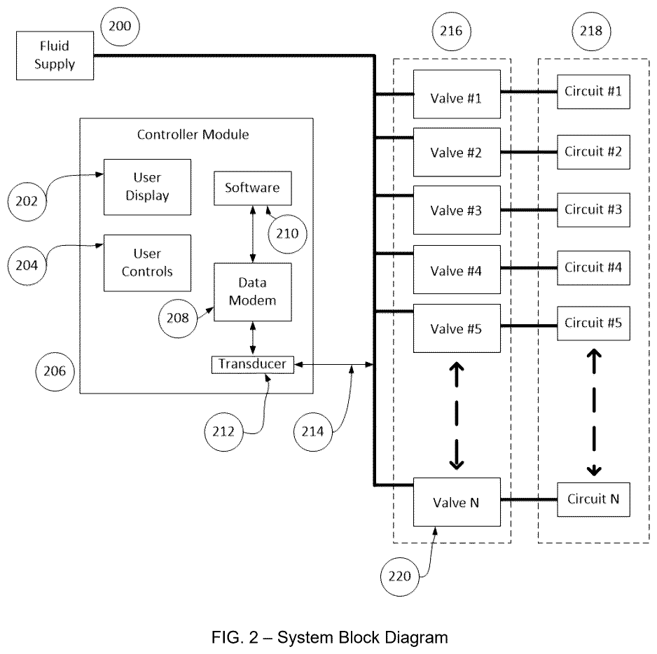

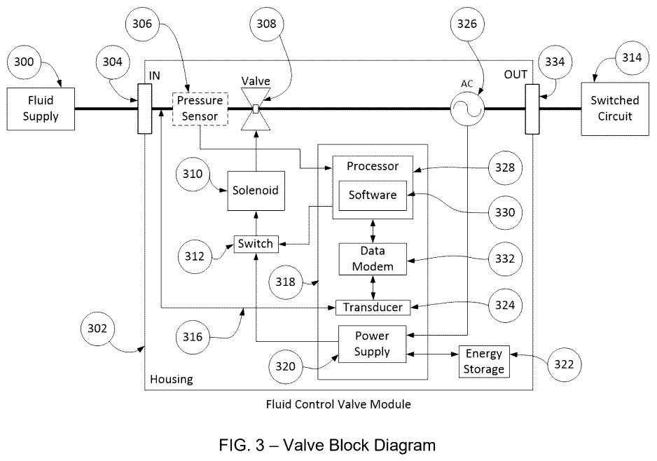

The preferred embodiment system block diagram of the present invention is shown in FIG. 2 as an integrated fluid control system. In the context of this preferred embodiment the terms water and fluid are used interchangeably. Fluid supply system 200 provides the common source of fluid to be controlled by the system. User display 202 and user controls 204 are integrated into housing 206 allowing an operator to configure and interact with the system by interfacing with control software 210. Examples of user display 202 include but are not limited to an active or passive LCD. User controls 204 for example could be a keypad or selector knob. Data modem 208 operates on digital information received from and transmitted to transducer 212. Examples of digital information formats supported by data modem 212 could be but not limited to industry standard OOK, MSK or BPSK protocols. Transducer 212 is coupled to fluid supply 200 with capability to impress and detect acoustic pressure waves within the enclosed fluid as acoustic pressure wave information. Examples of transducer types include but are not limited to piezoelectric, magnetic or MEMS. Control software 210 uses data modem 208 to send command and receive status information from each remote valve station in valve group 216. Individual valves 220 in valve group 216 are connected to common fluid supply system 200 at the inlet port and a switched output fluid circuit at the outlet port. The internal configuration of valve 220 is further detailed in FIG. 3. Switched fluid circuits within group 218 are individually activated based on associated valve turn on command.

The internal details for preferred embodiment valve station 220 containing integrated electronics utilized in system block diagram FIG. 2 is shown in block diagram FIG. 3. The valve housing 302 is typically connected in series using pipe between a common fluid supply and switched circuit. The fluid supply 300 is connected to valve housing inlet port 304 while switched circuit 314 is connected to the valve housing outlet port 334. Optional input pressure sensor 306 is coupled to the inlet port 304 reporting the measured pressure value to control software 330. A low cost example for pressure sensor 306 would be a MEMS device commonly used to measure fluid pressure. Fluid control valve 308 is either coupled directly to inlet port 304 or optional inlet pressure sensor 306 and solenoid 310, the valve is activated by solenoid 310. Several types of solenoid based flow control valves would be apparent to a skilled artisan whereby one example could be a diaphragm valve. Data modem 332 operates on the digital data information for interface with control software 330 executing on processor 328. Description for operation of transducer 324 and data modem 332 has been provided above with discussion in reference to FIG. 2. Transducer 324 is internally coupled by connection 316 to inlet port 304 with capability to impress and detect acoustic pressure waves within the enclosed fluid. Data modem 332, processor 328, power supply 320 and other various support circuits reside on electronics module 318. Power supply 320 is coupled to energy storage device 322 and voltage generator 326 to supply internal valve module power. During valve off condition, energy storage device 322 powers internal circuitry monitoring for acoustic pressure wave communications within the fluid supply system. Examples of energy storage device types include but are not limited to super/ultra capacitors, rechargeable battery or combination of the two devices. When a valve on command is received, energy storage device 322 provides the initial voltage/current to operate valve 308 thereby allowing fluid flow to start through voltage generator 326. Micro voltage generators can be fabricated in several physical configurations for the impeller design including axial, centrifugal and mixed flow. Upon the application of fluid flow, voltage generator 326 will then start supplying internal power for the valve electronics and to recharge energy storage device 322. Later, upon a preset condition control software 330 will command voltage switch 312 to turn off shutting valve 308 and stopping fluid flow through voltage generator 326. This preset condition could represent a fixed time period pre-programmed for a particular valve or received over the wireless interface. Based on digital information operated on by data modem 332, control software 330 can command voltage switch 312 to either an on or send status. These operational limitations are present based on acoustic pressure wave data communications can not normally be supported under conditions where fluid is flowing within the fluid source or supply network. When voltage switch 312 is turned on from the processor control signal, voltage is applied to solenoid 310 thereby activating a solenoid plunger to open fluid control valve 308. Conversely via processor control signal, fluid control valve 308 is closed upon voltage switch 312 being commanded off by deactivation of the solenoid plunger.

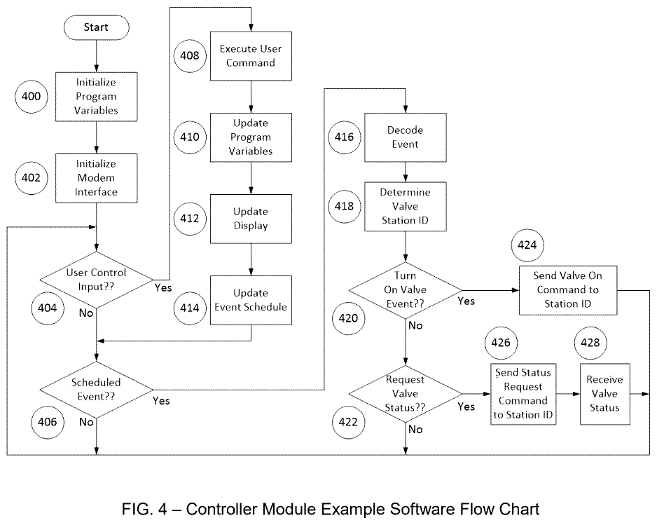

FIG. 4 shows an example software flowchart describing the operation of control module control software 210 as a set of process steps. Beginning at the flowchart “Start”, after power-up the program variables and modem hardware interfaces are initialized in steps 400 and 402 respectively. After initialization, the software enters a continuous wait loop monitoring for either a user control input 404 or a scheduled event 406 to occur. The scheduled events are driven by a processor-based calendar/clock function. Example scheduled events maintained for each independent valve station within the valve group, can include but are not limited to valve turn on, valve turn off and read status. When a user control input 404 is detected, the software will first execute the user command 408, then update program variables 410, then update the display 412 and finally update the event schedule 414. The user enters commands using controls 208 and display updates are provided to display 206. When a scheduled event 406 is detected, the software will first decode the event 416 to determine required action and then determine the valve station ID 418 to receive the action. When a read status event 422 is detected, the software will send a status request 426 to the specific station ID and receive a parameter status 428 from the same station ID. Further, upon detection of a turn on valve event 420 the software will send a valve on command 424 to the specific station ID. Upon completion of the command processing the software will return to the continuous wait loop.

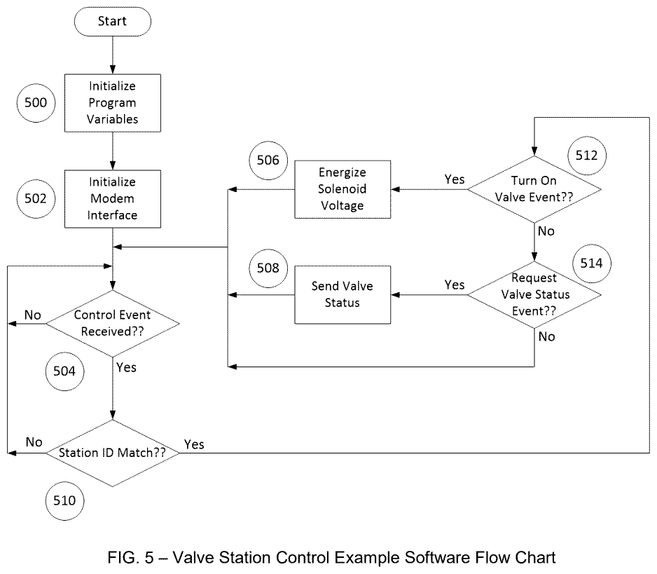

FIG. 5 shows an example software flowchart describing the operation of valve control software 330 as a set of process steps. Beginning at the flowchart “Start”, after power-up the program variables and modem interfaces are initialized in steps 500 and 502 respectively. After initialization, the software enters a continuous wait loop monitoring for a control event 504 to be received. When control event 504 is received, the station ID match 510 is checked before processing the control event. Each station has a unique station ID whereby control events are only processed by the specified station. When a turn on valve event 512 is detected, the software will energize the solenoid valve 506 by commanding the voltage switch on. Further, upon detection of a status request event 514 the software will send the valve status 508 back to the controller module. Upon completion of the control event processing the software will return to the continuous wait loop.

An alternate embodiment of the present invention consists of replacing the acoustic pressure wave data communication interface connection between a valve station and the controller module with an industry standard wireless format. Any commonly available industry standard wireless protocol (example Wi-Fi) can be used to implement the RF digital communication interface. While adding complexity (antenna component) to the valve station hardware configuration, an RF based interface would serve to support further distances between stations. Such a system could be implemented utilizing a combination both wireless interface types to meet any environmental conditions.

Applications so far described for the present invention span residential, commercial and industrial systems whereby remote activation of fluid control valves is required. An example residential application where remote activation is not required would include electrically activated (touch less) toilet or sink fluid valve control. Current systems are powered by either a dedicated battery pack or AC transformer connected to wall power. The valve configuration shown in FIG. 3 would remain the same except the data communication interface would be replaced with a touch less sensor, for example IR or capacitive sensing, coupled to the processor used to activate the valve. The sensor would serve to detect user actions in controlling the valve operation such as turn on. Another example could implement a self monitoring automatic shutoff valve type operation where an indirect measurement of flow rate is utilized. The voltage output of the generator is roughly proportional to inlet pressure and flow rate. Control software would monitor the generator voltage during continual flow to determine under/over flow conditions. Additionally the optional input pressure sensor can be utilized to determine inlet pressure to the generator. If an out of tolerance condition for flow or pressure was detected the valve would be deactivated cutting fluid flow to the output port. Further, the faulted condition could be reported to a control module using the wireless communications interface.

The claimed invention is:

1. A fluid control valve comprising:
a. a housing including a fluid inlet and a fluid outlet configured to be connectable in series to a fluid pipe;
b. a fluid control valve coupled to the fluid inlet and coupled to a solenoid circuit, the fluid control valve mechanically opening and closing in response to the solenoid circuit;
c. a voltage generator circuit coupled to the fluid control valve and coupled to the fluid outlet port, the voltage generator circuit generating voltage in response to fluid flow;
d. a power supply circuit coupled to the voltage generator circuit and coupled to an energy storage device, the power supply circuit generating regulated power in response to the voltage generator and the energy storage device;
e. a voltage switch circuit coupled to the solenoid circuit and coupled to the power supply, the voltage switch circuit controlling the application of voltage to the solenoid circuit in response to a control signal;
f. a data modem coupled to an external wireless communication interface and coupled to a processor, the data modem operating on digital information in response to the processor or external wireless data communication interface;
g. a processor executing control software;
h. wherein the processor is configured to apply a control signal to the voltage control switch circuit;
i. wherein the control software is configured to control the application of a control signal to the voltage switch circuit;
j. wherein the control software is configured to communicate digital information with an external wireless data communication interface; and
k. wherein the power supply circuit is configured to recharge the energy storage device.

2. The system of claim 1, wherein the external wireless data communication interface comprises an acoustic pressure wave type interface.

3. The system of claim 1, wherein the external wireless data communication interface is comprises a RF signaling type interface.

4. A fluid control system comprising:
a. a fluid supply system configured to be connected to an least one fluid control valve;
b. a controller module configured to be acoustically coupled to the fluid supply system by a transducer;
c. a fluid control valve configured to be acoustically coupled to the fluid supply system by a transducer;
d. a controller module processor executing control software;
e. wherein the controller module software is configured to transmit acoustic pressure wave information onto the fluid supply system and receive acoustic pressure wave information from the fluid supply system;
f. a fluid control valve module processor executing control software; and
g. wherein the fluid control valve software is configured to transmit acoustic pressure wave information onto the fluid supply system and receive acoustic pressure wave information from the fluid supply system.

5. A fluid control valve comprising:
a. a housing including a fluid inlet and a fluid outlet configured to be connectable in series to a fluid pipe;
b. a fluid control valve coupled to the fluid inlet and coupled to a solenoid circuit, the fluid control valve mechanically opening and closing in response to the solenoid circuit;
c. a voltage generator circuit coupled to the fluid control valve and coupled to the fluid outlet port, the voltage generator circuit generating voltage in response to fluid flow;
d. a power supply circuit coupled to the voltage generator circuit and coupled to an energy storage device, the power supply circuit generating regulated power in response to the voltage generator and the energy storage device;
e. a voltage switch circuit coupled to the solenoid circuit and coupled to the power supply, the voltage switch circuit controlling the application of voltage to the solenoid circuit in response to a control signal;
f. a sensor input coupled to the processor, the sensor input sending an input signal to the processor in response to user actions;
g. a processor executing control software;
h. wherein the processor is configured to apply a control signal to the voltage control switch circuit;
i. wherein the control software is configured to control the application of a control signal to the voltage switch circuit;
j. wherein the control software is configured to receive the sensor input signal to control valve operation; and
k. wherein the power supply circuit is configured to recharge the energy storage device.
